(19) United States
(12) Patent Application Publication
(10) Pub. No.: US 2003/0019749 A1
(43) Pub. Date: Jan. 30, 2003

(54) Apparatus and method for treating a measuring probe

(75) Inventors: Jean Laragne, Steinhausen (CH); Matthias Ruegg, Flawil (CH); Daniel Caderas, Lohn (CH)

Correspondence Address: Friedrich Kueffner, Suite 1921, 342 Madison Avenue, New York, NY, 10173, US

(73) Assignee: Mettler-Toledo GmbH

(21) Appl. No.: 10/202,145

(22) Filed: Jul. 23, 2002

(30) Foreign Application Priority Data
Jul. 24, 2001 (DE) 101 35 237.9

(51) Int. Cl. G01N 27/26

(52) U.S. Cl. 204/402

(57) ABSTRACT

1. An apparatus for treating a measuring probe has a treatment chamber (104) with a chamber inlet (106) and a chamber outlet (108). A conveyor device (110) selectively conveys one of a plurality of treatment media (G, W, R, E, Z) from its respective supply port (118a, 118b, 118c, 118d, 118e) to the chamber inlet (106) and into the treatment chamber (104). The conveyor device (110) has a collector conduit (120) and a conveyor pump (122), the latter arranged between the collector conduit (120) and the chamber inlet (106). Each of the supply ports (118a, 118b, 118c, 118d, 118e) has its own shutter device (124a, 124b, 124c, 124d, 124e) arranged directly at the collector conduit (120).

### BACKGROUND OF THE INVENTION

The invention relates to an apparatus for treating a measuring probe of the kind that is used to measure electro-chemical properties such as pH-values. The treatment performed by the apparatus typically includes rinsing and cleaning, for which the apparatus is equipped with a treatment chamber with a chamber inlet and a chamber outlet for the treatment medium. The apparatus also has a conveyor device to convey a selected treatment medium from one of a plurality of reservoir connections to the inlet of the treatment chamber.

It is a known problem in working with electro-chemical measuring probes such as pH-electrodes that after a certain time period of usage, every measuring probe has to be cleaned, and it also has to be calibrated occasionally. The required cleaning- and calibrating procedures are known per se and are based on the concept that the relevant portion of the outside surface of the probe is brought into contact with a plurality of treatment media in a prescribed sequence. These treatment media include in particular different kinds of cleaning fluids such as acidic or caustic media, rinsing fluids such as water or organic solvents, rinsing gases such as air, nitrogen or in some cases a noble gas, as well as different kinds of calibration fluids and -gases. For example a pH-electrode is cleaned with a cleaning fluid when needed, and the cleaning fluid is subsequently flushed away with a rinsing fluid such as water. As a rule, after the cleaning and rinsing, the pH-meter is calibrated by means of two or in some cases several different standardized buffer solutions.

In GB 2033583, an apparatus for the cleaning of an electrode is described, which has a plurality of manipulating means by which the electrode is inserted into and retracted from a container that is filled with cleaning fluid. This apparatus has the disadvantage of being very complex. In addition, the use of the apparatus for cleaning and calibration would be very laborious, because one would either need different containers for the individual fluids to be used, or else an additional device for exchanging the fluids in the container.

In EP 0106858, an interchangeable probe is described for use in reactor vessels for chemical and micro-biological processes. The interchangeable probe is designed so that a measuring sensor contained in the probe can be cleaned and calibrated. This known apparatus has a treatment chamber with an inlet and an outlet for a treatment medium that is supplied to the chamber by means of a conveyor device which is not described in detail. A calibration fluid or calibration gags is mentioned specifically as a treatment medium.

To prevent the intermixing of the different treatment media that have to be supplied to the treatment chamber for the cleaning and/or calibrating of the measuring probe, the known conveyor devices have a separate conveyor section for each individual treatment medium. An individual conveyor section in this arrangement includes a conveyor pump that is arranged between the medium reservoir and the medium inlet into the chamber, or a conveyor unit based on the Venturi principle.

### OBJECT OF THE INVENTION

The present invention has the objective of providing an improved apparatus that is distinguished in particular by a less complicated and thus more cost-effective design configuration as well as by greater adaptability to different applications. The invention further has the objective of proposing a method in which the inventive apparatus is used for treating a measuring probe.

### SUMMARY OF THE INVENTION

The first of the aforementioned objectives is met by a treatment apparatus that has a treatment chamber with a chamber inlet and a chamber outlet for the treatment medium. The treatment medium is selectable from a plurality of treatment media that are available from their respective supply port connections. A conveyor device that forms part of the apparatus brings the selected treatment medium from its supply port to the chamber inlet and thus into the treatment chamber. Distinctive features of the apparatus according to the invention include that the conveyor device has a common collector conduit and conveyor pump for the treatment media, with the pump being arranged between the collector conduit and the chamber inlet, and that each of the supply ports has its own shutter device arranged directly at the collector conduit. The selection of a treatment medium is accomplished simply by opening the respective shutter device, while the shutter devices of all of the other treatment media remain closed. With the individual shutter devices being arranged directly at the collector conduit, i.e., substantially without any dead volume between the shutter device and the collector conduit, the entire conveying path from the selected medium reservoir to the treatment chamber is flooded by the stream of treatment medium that is being conveyed, whereby residues of other treatment media are removed. As this can be accomplished with one single common conveyor pump, the inventive concept leads to a simple and cost-effective arrangement. In comparison to a conveyor device that is based on the Venturi principle, the inventive apparatus furthermore has the advantage that, e.g., a highly concentrated cleaning solution can be conveyed to the treatment chamber in an efficient manner.

To meet the aforementioned further objective, the invention also provides a method of cleaning a measuring probe by means of the inventive treatment apparatus. With the measuring probe placed in the treatment chamber, a cleaning fluid is brought through the chamber inlet into the treatment chamber by means of the conveyor device. The method has the distinguishing feature that after the cleaning, a rinsing process is performed in which the conveyor device and the treatment chamber are flushed out with rinsing gas and rinsing fluid in an alternating sequence.

The invention further provides a method of calibrating a measuring probe by means of the inventive treatment apparatus. A calibrating fluid is brought through the chamber inlet into the treatment chamber by means of the conveyor device. The method has the distinguishing feature that prior to calibrating the measuring probe, a rinsing process is performed in which the conveyor device and the treatment chamber are flushed out with rinsing gas and rinsing fluid in an alternating sequence.

Thus, the inventive methods have in common that a rinsing process is performed after a cleaning process and/or before a calibration process, where the rinsing process consists of flushing out the treatment chamber with rinsing gas and rinsing fluid in an alternating sequence.

In a preferred embodiment of the inventive apparatus, the plurality of treatment media includes at least a rinsing gas, a rinsing fluid, as well as a cleaning fluid. The respective supply ports are arranged at the collector conduit in a sequence that begins with the supply port for the rinsing gas at the far end of the conductor conduit in relation to the conveyor pump, with the supply port for the rinsing fluid following next. With this arrangement, residual quantities of a previously used treatment medium remaining in the conveyor device can be removed in a simple and efficient manner by operating the conveyor device alternatingly with rinsing gas and rinsing fluid. In a further development of the same embodiment, the plurality of treatment media additionally includes at least one calibration fluid. Preferred is an arrangement with two or even more calibration fluids to allow a two-point calibration or a multi-point calibration of a measuring probe in the treatment chamber.

In a further version of the basic embodiment, the conveyor pump can be brought into an idle state in which the pump is inactive but the treatment medium can flow unimpeded from the collector conduit through the pump to the inlet of the treatment chamber. In particular, this feature is intended to facilitate the use a treatment medium that is already pressurized such as, e.g., compressed air or tap water.

In principle, a variety of pumps are suitable for use as conveyor pumps. As an advantageous choice, the conveyor pump is configured as a reciprocating piston pump.

A treatment medium leaving the treatment chamber through the chamber outlet—in particular as a result of additional treatment medium flowing into the chamber—can be sent, e.g., to a holding container. In one arrangement of the inventive apparatus, the outlet of the treatment chamber can be connected to at least one of the supply ports. This allows treatment medium to be returned to its respective reservoir supply through the corresponding supply port, which is ecologically advantageous in particular for toxic and/or aggressive treatment fluids, in addition to saving cost.

In principle, the shutter devices and the conveyor pump can be controlled manually. As a further feature, the invention provides a control device, which offers the possibility of standardizing the cleaning- and/or calibrating procedure. In a particularly advantageous arrangement, the control device has a measuring device to monitor at least one operating parameter that is indicative of the operating condition of a measuring probe in the treatment chamber. This offers, e.g., the possibility of automating the operation of the measuring probe by monitoring whether the aforementioned operating parameter is within a prescribed range and by initiating a cleaning- and/or calibration cycle if the operating parameter leaves the prescribed range.

In principle, the treatment chamber can be configured to stand by itself. However, as an advantageous arrangement, the treatment chamber is equipped with a connector element to establish a sealed connection to a corresponding connector element of a measuring container for a substance to be measured. A further developed version of this arrangement has a seal-tight closing device by which the interior volume of the treatment chamber can be closed off against the measuring container. In particular, the seal-tight closing device has the purpose of isolating the measuring container from the treatment chamber during a cleaning and/or calibration cycle. Another embodiment of the inventive apparatus is equipped with a probe-moving mechanism that moves the probe between the treatment chamber and a measuring container. Any of the foregoing embodiments of the invention may also be equipped with a flow sensor for the treatment medium, in order to monitor the operation of the apparatus and, in particular, to ascertain that the required inflow of treatment medium is actually taking place during a rinsing-, cleaning-, or calibrating process.

### BRIEF DESCRIPTION OF THE DRAWING

In the attached drawing:

FIG. 1 represents an apparatus according to the invention in a partly schematic view; and

FIG. 2 represents a further embodiment of the inventive apparatus, shown likewise in a partly schematic view.

### DETAILED DESCRIPTION OF PREFERRED EMBODIMENTS

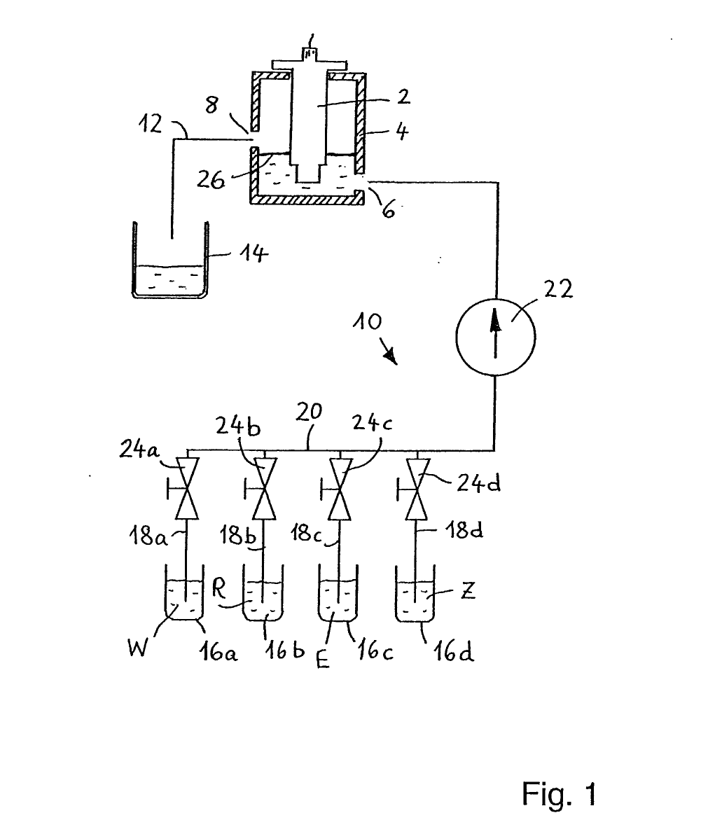

The apparatus shown in FIG. 1 for cleaning and calibrating a measuring probe 2 has a treatment chamber 4 with a chamber inlet 6 and a chamber outlet 8. A conveyor device 10 serves to convey a treatment medium through the chamber inlet 6 into the treatment chamber 4. In the illustrated example, the chamber outlet 8 is arranged at a higher level than the chamber inlet 6 and connected to an outlet conduit 12 leading to a holding container 14.

The treatment medium is selectable from a plurality of treatment media such as, e.g., water W, a cleaning fluid R, a first calibration fluid E, or a second calibration fluid Z, which are contained in the respective supply reservoirs 16a, 16b, 16c, and 16d. The supply reservoirs are connected to the conveyor device through the supply ports 18a, 18b, 18c, and 18d, respectively. The conveyor device 10 includes a collector conduit 20 as well as a conveyor pump 22 that is arranged between the collector conduit 20 and the chamber inlet 6. Each of the supply ports is equipped with its own shutter device 24a, 24b, 24c, and 24d, respectively, with the shutter devices being connected to the collector conduit 20. The shutter devices are arranged to be as close as possible to the collector conduit 20, for example at a distance equal to twice or three times the inside diameter of the collector conduit. This arrangement of the shutter devices, also referred to herein as “directly at the collector conduit”, has the purpose of minimizing the dead volume that lies between each of the shutter devices and the collector conduit.

For example to clean the measuring probe 2, the probe is inserted in the measuring chamber 4 while at first all of the shutter devices 24a to 24d are closed and the conveyor pump 22 is switched off. Next, the conveyor pump 22 is switched on and the shutter device 24b at the supply reservoir 16b of the cleaning fluid R is opened. Cleaning fluid R is conveyed through the chamber inlet 6 into the treatment chamber 4. When the level 26 of the cleaning fluid R in the treatment chamber 4 has reached the height of the chamber outlet 8, the cleaning fluid R runs through the outlet conduit 12 into the holding container 14. If desired, the further supply of cleaning fluid R is interrupted for a certain length of time, to allow the cleaning action on the measuring probe 2 to take place over a certain time period. The introduction of another treatment medium occurs in like manner, by opening the respective shutter device while at the same time all of the other shutter devices remain closed. This will at first cause the remaining cleaning fluid R to be expelled from the conveyor device by the inflow of the new treatment fluid. This expulsion can be achieved in particular by sending water and/or air through the conveyor device so that, e.g., a calibration fluid can next be introduced without being contaminated by remaining amounts of cleaning fluid.

In a variation of the arrangement shown in FIG. 1, the chamber outlet 8 could be at a lower height than the chamber inlet 6, e.g., to achieve a particularly effective cleaning of the measuring probe. In this alternative configuration, the contact between the measuring probe and the cleaning fluid occurs not by static immersion, but rather by a constant stream of treatment fluid running past the measuring probe.

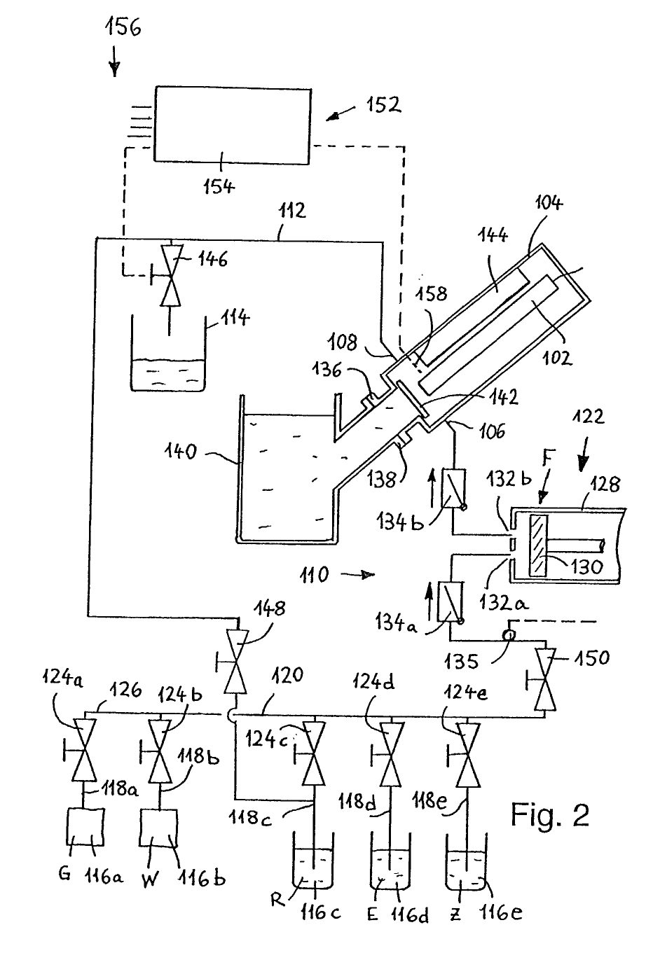

The apparatus of FIG. 2 for cleaning and calibrating a measuring probe 102 has a treatment chamber 104 with a chamber inlet 106 and a chamber outlet 108. A conveyor device 110 serves to convey a treatment medium through the chamber inlet 106 into the treatment chamber 104. The chamber outlet 108 is connected to an outlet conduit 112 leading to a holding container 114.

The treatment medium is selectable from a plurality of treatment media including a rinsing gas G such as air or nitrogen, a rinsing fluid such as water W, a cleaning fluid R such as, e.g., an acidic or caustic medium, as well as a first calibration fluid E and a second calibration fluid Z. For example, to calibrate a pH electrode, two buffer solutions of different, known pH values are used. Depending on the application, it is also possible to use more than two calibration fluids. Each of the aforementioned treatment media is contained in its own reservoir container 116a, 116b, 116c, 116d or 116e, respectively, with the liquid media preferably being held in fluid containers and the rinsing gas, e.g., in a pressurized gas bottle. For water and air in particular, it may be practical to connect the respective supply ports to a supply pipeline.

The conveyor device 110 includes a collector conduit 120 as well as a conveyor pump 122 that is arranged between the collector conduit 120 and the chamber inlet 106. Each of the supply ports 118a, 118b, 118c, 118d and 118e is equipped with its own shutter device 124a, 124b, 124c, 124d and 124e, respectively, with the shutter devices being connected to the collector conduit 120. As in the embodiment of FIG. 1, the shutter devices are arranged to be as close as possible to the collector conduit 120, for example at a distance equal to twice or three times the inside diameter of the collector conduit. This direct proximity of the shutter devices to the collector conduit 120 has the purpose of minimizing the dead volume that lies between each of the shutter devices and the collector conduit.

The respective supply ports are arranged at the collector conduit 120 in a sequence that begins with the supply port 118a for the rinsing gas G at the far end 126 of the collector conduit in relation to the conveyor pump. The supply port 118b for the rinsing fluid W is next in line, followed by the further supply ports 118c, 118d, and 118e of the cleaning fluid R as well as the calibration fluids E and Z. With this arrangement, residual quantities of a previously used treatment medium remaining in the conveyor device 110 can be removed in a simple and efficient manner by alternatingly sending rinsing gas and rinsing fluid through the conveyor device. It is advantageous to start with rinsing gas, followed by rinsing fluid and finally another flush of rinsing gas. These steps may be repeated, if necessary.

To facilitate the use of a pressurized medium such as, e.g., compressed air or tap water, the conveyor pump 122 can be brought into an idle position in which treatment medium can flow unimpeded from the collector conduit 120 to the chamber inlet 106 of the treatment chamber 104. The conveyor pump 122 in the illustrated example is configured as a reciprocating piston pump with a piston 130 in a cylinder housing 128. The piston 130 can be stopped in a free-flow position F, which allows an unimpeded fluid flow from the pump inlet 132a to the pump outlet 132b. Back-flow preventing devices 134a and 134b are arranged so that the stream of the medium can flow only in the desired direction from the collector conduit 120 to the chamber inlet 106. In addition, a flow sensor 135, e.g., a capacitative flow-sensor device, is arranged between the collector conduit and the conveyor pump to ascertain that treatment medium is being supplied and to monitor the proper functioning of the entire apparatus.

The treatment chamber 104 is equipped with a connector flange 136 to establish a sealed connection to a matching connector flange 138 of a measuring container 140 for a substance to be measured. The treatment chamber 104 is further equipped with a seal-tight closing device 142 (indicated schematically without details) by which the interior volume of the treatment chamber 104 can be closed off against the measuring container 140. A probe-moving mechanism 144 (shown without details) is used to advance the probe 102 from the treatment chamber 104 into the measuring container 140 and subsequently retract the probe back into the treatment chamber. Advantageous configurations of the treatment chamber 104 may be found, e.g., in CH 673783, CH 673895, and EP 0882896.

As may be seen in FIG. 2, the chamber outlet 108 can be connected by way of the outlet conduit 112 to the supply port 118c for the cleaning fluid R. The treatment medium coming out of the treatment chamber 104 can be sent selectively either to the holding container 114 or—in the case of a cleaning fluid—back to the respective supply reservoir 116c by opening either a first outlet shutter device 146 from the outlet conduit 112 to the holding container 114 or a second outlet shutter device 148 from the outlet conduit 112 to the supply port 118c for a cleaning fluid R. A further shutter device 150 is arranged between the collector conduit 120 and the conveyor pump 122.

A control device 152, represented schematically in FIG. 2, includes a control unit 154, which is connected to the shutter devices 124a to 124e as well as 146, 148, 150, and to the conveyor pump 122 by way of communication lines 156 (not shown in detail). The control device 152 further includes a measuring device 158 to monitor at least one operating parameter that is indicative of the operating condition of a measuring probe 102.

The apparatus represented by FIG. 2 is operable in an automated operating mode in which, for example, the variable value of the operating parameter indicated by the measuring device 158 is monitored in relation to prescribed range limits and a cleaning- and/or calibration cycle is initiated if the operating parameter leaves the prescribed range. As a first step in this cycle, a measurement that may be in process is interrupted, the measuring probe 102 is retracted from the measuring container 140 into the treatment chamber 104, and the treatment chamber 104 is closed off against the measuring container 140 by means of the closing device 142. Next, a cleaning- or calibration procedure is performed according to the following description. The two procedures can also be performed in immediate sequence, i.e., a cleaning procedure followed by a calibration.

In the cleaning procedure, cleaning fluid R is conveyed through the chamber inlet 106 into the treatment chamber 104 by means of the conveyor device 110. To achieve the desired cleaning effect, one has to allow a sufficient length of time for the cleaning action on the measuring probe 102 to take place, either by sending a stream of cleaning fluid through the treatment chamber for a certain time period, or by leaving the cleaning fluid in the treatment chamber for a certain time period with the conveyor device switched off. Next, a rinsing procedure is performed, as has already been described above, in which the conveyor device 110 and the treatment chamber 104 are flushed out with rinsing gas G and rinsing fluid W in an alternating sequence. While the rinsing gas, and in some arrangements also the rinsing fluid, is sent through the apparatus, the conveyor pump is set to the idle position.

The calibration process begins with a rinsing procedure as just described. Next, a calibration fluid E or Z is conveyed through the chamber inlet 106 into the chamber 104 by means of the conveyor device 110. Subsequently, the measuring probe or the measuring instrument connected to the probe is calibrated by a procedure that is known per se. To use the customary calibration method with more than one reference point, the aforedescribed calibration process is run in a repetitive sequence with different calibration fluids, for example a first calibration fluid E and a second calibration fluid Z. If necessary, another rinse cycle is performed after the calibration process has been completed.

### LIST OF REFERENCE SYMBOLS

2 measuring probe

4 treatment chamber

6 chamber inlet

8 chamber outlet

10 conveyor device

12 outlet conduit

14 holding container

16a, 16b, 16c, 16d supply reservoir

18a, 18b, 18c, 18d supply port

20 collector conduit

22 conveyor pump

24a, 24b, 24c, 24d shutter device

26 fluid level

102 measuring probe

104 treatment chamber

106 chamber inlet

108 chamber outlet

110 conveyor device

112 outlet conduit

114 holding container

116a, 116b, 116c, 116d, 116e supply reservoir

118a, 118b, 118c, 118d, 118e supply port

120 collector conduit

122 conveyor pump

124a, 124b, 124c, 124d, 124e shutter device

126 end of collector conduit 120

128 cylinder housing of conveyor pump 122

130 piston

132a, 132b pump inlet, pump outlet

134a, 134b back-flow preventing device

135 flow sensor

136 connector element

138 matching connector element

140 measuring container

142 closing device

144 probe-moving mechanism

146 shutter device

148 shutter device

150 shutter device

152 control device

154 control unit

156 communication lines

158 measuring device

G rinsing gas

W water

R cleaning fluid

E first calibration fluid

Z second calibration fluid

F free-flow position

What is claimed is:

1. An apparatus for treating a measuring probe, comprising a treatment chamber (4, 104) with a chamber inlet (6, 106) and a chamber outlet (8, 108), and further comprising a conveyor device (10, 110) operable to convey a treatment medium selected from a plurality of treatment media from one of a plurality of supply ports (18a, 18b, 18c, 18d, or 118a, 118b, 118c, 118d, 118e) through the chamber inlet (6, 106) into the treatment chamber (4, 104); wherein the conveyor device (10, 110) has a collector conduit (20, 120), a conveyor pump (22, 122) arranged between the collector conduit (20, 120) and the chamber inlet (6, 106), and wherein each of the supply ports (18a, 18b, 18c, 18d, or 118a, 118b, 118c, 118d, 118e) has its own shutter device (24a, 24b, 24c, 24d, or 124a, 124b, 124c, 124d, 124e) arranged directly at the collector conduit (20, 120).

2. The apparatus of claim 1, wherein the plurality of treatment media comprises at least a rinsing gas (G), a rinsing fluid (W) and a cleaning fluid (R) available from their respective supply ports (118a, 118b, 118c), said supply ports being arranged along the collector conduit (120) in a sequence that begins with the supply port (118a) for the rinsing gas (G) at a far end (126) of the collector conduit (120) in relation to the conveyor pump (122) and continues next with the supply port (118b) for the rinsing fluid (W).

3. The apparatus of claim 2, wherein the plurality of treatment media further comprises at least one calibration fluid (E, Z) available from at least one respective supply port (118d, 118e).

4. The apparatus of claim 1, wherein the conveyor pump (122) can be set into an idle position (F) in which a stream of treatment medium can flow unimpeded from the collector conduit (120) through the conveyor pump (122) to the chamber inlet (106).

5. The apparatus of claim 1, wherein the conveyor pump (122) comprises a reciprocating piston pump.

6. The apparatus of claim 1, wherein the chamber outlet (108) can be connected to at least one of the supply ports (118c).

7. The apparatus of claim 1, further comprising a control device (152) operable to actuate the shutter devices (124a, 124b, 124c, 124d, 124e) and to control the conveyor pump (122).

8. The apparatus of claim 7, wherein the control device (152) comprises a measuring device (158) to monitor at least one operating parameter that is indicative of an operating condition of a measuring probe (102) placed in the treatment chamber (104).

9. The apparatus of claim 1, wherein the treatment chamber (104) comprises a connector element (136) to establish a sealed connection to a corresponding connector element (138) of a measuring container (140) containing a substance to be measured.

10. The apparatus of claim 9, further comprising a closing device (142) to close off an interior space of the treatment chamber (104) against the measuring container (140).

11. The apparatus of claim 9, further comprising a probe-moving mechanism (144) operable to advance a measuring probe (102) from the treatment chamber (104) into the measuring container (140) and subsequently retract the measuring probe (102) from the measuring container (140)

12. The apparatus of claim 1, further comprising a flow sensor (135) for monitoring a flow of treatment medium.

13. A method of operating the apparatus of claim 2 to clean a measuring probe placed in the treatment chamber (104), said method comprising:
a) by means of the conveyor device (110), conveying the cleaning fluid (R) through the chamber inlet (106) into the chamber (104), and
b) performing a rinsing procedure in which the conveyor device (110) and the treatment chamber (104) are flushed out with rinsing gas (G) and rinsing fluid (W) in an alternating sequence.

14. A method of operating the apparatus of claim 3 to calibrate a measuring probe placed in the treatment chamber (104), said method comprising:
a) performing a rinsing procedure in which the conveyor device (110) and the treatment chamber (104) are flushed out with rinsing gas (G) and rinsing fluid (W) in an alternating sequence, and
b) after the rinsing procedure, conveying the calibration fluid (E, Z) by means of the conveyor device (110) through the chamber inlet (106) into the chamber (104).
